(19) United States
(12) Patent Application Publication
(10) Pub. No.: US 2021/0279569 A1
(43) Pub. Date: Sep. 9, 2021

(54) METHOD AND APPARATUS WITH VECTOR CONVERSION DATA PROCESSING

(71) Applicant: SAMSUNG ELECTRONICS CO., LTD., Suwon-si (KR)

(72) Inventor: Minkyu KIM, Suwon-si (KR)

(73) Assignee: SAMSUNG ELECTRONICS CO., LTD., Suwon-si (KR)

(21) Appl. No.: 17/019,688

(22) Filed: Sep. 14, 2020

(30) Foreign Application Priority Data
Mar. 9, 2020 (KR) 10-2020-0029072

(51) Int. Cl. G06N 3/08; G06F 16/25; G06F 16/22

(52) U.S. Cl. CPC G06N 3/08; G06F 16/2237; G06F 16/258

(57) ABSTRACT

A data processing method includes: generating an input vector by embedding input data; converting a dimension of the input vector based on a pattern of the input vector; and performing attention on the dimension-converted input vector.

### CROSS-REFERENCE TO RELATED APPLICATIONS

This application claims the benefit under 35 USC § 119(a) of Korean Patent Application No. 10-2020-0029072 filed on Mar. 9, 2020 in the Korean Intellectual Property Office, the entire disclosure of which is incorporated herein by reference for all purposes.

### BACKGROUND

### 1. Field

The following description relates to a data processing method and apparatus using vector conversion.

### 2. Description of Related Art

In data processing through neural networks, in the case of data processing using an encoder-decoder structure, the encoder neural network may read an input sentence and encode the sentence into a vector of fixed length, and the decoder may output a conversion from the encoded vector.

There may be two issues in a typical recurrent neural network (RNN)-based sequence-to-sequence model. The first issue lies in that a loss of information may occur because all information needs to be compressed in a single vector of fixed size, and the second issue lies in that a vanishing gradient problem may occur, which is a chronic issue of RNN.

Due to these issues, in the machine translation field using typical RNN-based sequence-to-sequence model, a quality and/or accuracy of translation of an output sentence may decrease when a length of the input sentence increases. Moreover, while a typical attention method may be used to correct the decrease in the accuracy of the output sentence, the typical attention method may use a fixed vector size and thus may be inefficient in terms of memory or system resources.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a data processing method includes: generating an input vector by embedding input data; converting a dimension of the input vector based on a pattern of the input vector; and performing attention on the dimension-converted input vector.

The generating may include: converting the input data into a dense vector; and generating the input vector by performing position embedding on the dense vector based on the position of the input data with respect to an entire input.

The converting may include: determining an embedding index with respect to the input vector based on the pattern of the input vector; and converting the dimension of the input vector based on the embedding index.

The determining may include determining, as the embedding index, an index corresponding to a boundary between a component to be used in the performing of the attention and a component not to be used in the performing of the attention, among components of the input vector.

The component not to be used in the performing of the attention may include a value of “0”.

The converting of the dimension of the input vector based on the embedding index may include reducing the dimension of the input vector by removing a component corresponding to an index greater than the embedding index from the input vector.

The input vector may include a plurality of input vectors, and

the embedding index may be an index having a max position among indices corresponding to boundaries between components of the input vectors to be used in the performing of the attention and components of the input vectors not to be used in the performing of the attention.

The method may include restoring the dimension of the input vector on which the attention is performed.

The restoring may include increasing the dimension of the input vector on which the attention is performed to the same dimension as the input vector based on an embedding index determined based on the pattern of the input vector.

The increasing may include performing zero padding on a component corresponding to an index greater than or equal to the embedding index with respect to the input vector on which the attention is performed.

The method may include: generating an output sentence as a translation of an input sentence, based on the input vector on which the attention is performed, wherein the input data corresponds to the input sentence.

A non-transitory computer-readable storage medium may store instructions that, when executed by a processor, configure the processor to perform the method.

In another general aspect, a data processing apparatus includes: a processor configured to: generate an input vector by embedding input data, convert a dimension of the input vector based on a pattern of the input vector, and perform attention on the dimension-converted input vector.

For the generating, the processor may be configured to: convert the input data into a dense vector, and generate the input vector by performing position embedding on the dense vector based on the position of the input data with respect to an entire input.

For the converting, the processor may be configured to: determine an embedding index with respect to the input vector based on the pattern of the input vector, and convert the dimension of the input vector based on the embedding index.

For the determining, the processor may be configured to determine, as the embedding index, an index corresponding to a boundary between a component to be used in the performing of the attention and a component not to be used in the performing of the attention, among components of the input vector.

The component not to be used in the performing of the attention may include a value of “0”.

For the converting, the processor may be configured to reduce the dimension of the input vector by removing a component corresponding to an index greater than or equal to the embedding index from the input vector.

The processor may be configured to restore the dimension of the input vector on which the attention is performed.

For the restoring, the processor may be configured to increase the dimension of the input vector on which the attention is performed to the same dimension as the input vector based on an embedding index determined based on the pattern of the input vector.

For the increasing, the processor may be configured to perform zero padding on a component corresponding to an index greater than the embedding index with respect to the input vector on which the attention is performed.

The apparatus may include a memory storing instructions that, when executed by the processor, configure the processor to perform the generating of the input vector, the converting of the dimension of the input vector, and the performing of the attention on the dimension-converted input vector.

Other features and aspects will be apparent from the following detailed description, the drawings, and the claims.

### BRIEF DESCRIPTION OF THE DRAWINGS

FIG. 1 illustrates an example of a data processing apparatus.

FIG. 2 illustrates an example of a processor.

FIG. 3 illustrates an example of a position embedding operation.

FIG. 4 illustrates an example of an embedding operation with respect to an entire input.

FIG. 5 illustrates an example of input data converted into an input vector.

FIG. 6 illustrates an example of an embedding index.

FIG. 7 illustrates an example of attention.

FIG. 8 illustrates an example of an operation of a processor.

FIG. 9 illustrates an example of an operation of a data processing apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known may be omitted for increased clarity and conciseness.

The terminology used herein is for the purpose of describing particular examples only and is not to be limiting of the disclosure. As used herein, the singular forms “a”, “an”, and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof.

Although terms of “first” or “second” are used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Unless otherwise defined, all terms including technical and scientific terms used herein have the same meaning as commonly understood by one of ordinary skill in the art to which this disclosure pertains consistent with and after an understanding of the present disclosure. It will be further understood that terms, such as those defined in commonly-used dictionaries, are to be interpreted as having a meaning that is consistent with their meaning in the context of the relevant art and the present disclosure, and are not to be interpreted in an idealized or overly formal sense unless expressly so defined herein. The use of the term “may” herein with respect to an example or embodiment (for example, as to what an example or embodiment may include or implement) means that at least one example or embodiment exists where such a feature is included or implemented, while all examples are not limited thereto.

When describing the examples with reference to the accompanying drawings, like reference numerals refer to like constituent elements and a repeated description related thereto will be omitted. In the description of examples, detailed description of well-known related structures or functions will be omitted when it is deemed that such description will cause ambiguous interpretation of the present disclosure.

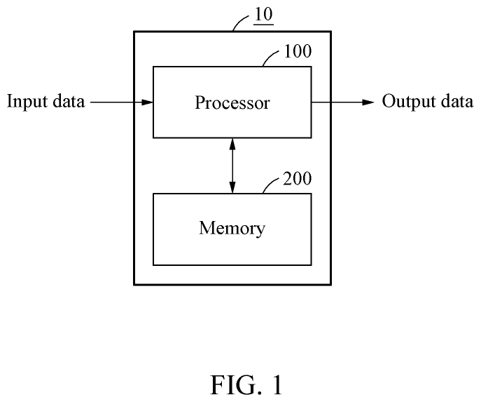

FIG. 1 illustrates an example of a data processing apparatus.

Referring to FIG. 1, a data processing apparatus 10 may process data. The data may include symbolic or numeric data in the form to operate a computer system. For example, the data may include an image, a character, a number, and/or a sound.

The data processing apparatus 10 may generate output data by processing the input data. The data processing apparatus 10 may process the data using a neural network.

The data processing apparatus 10 may generate an input vector from the input data, and efficiently process the input data using a conversion of the generated input vector. The input data may correspond to an input sentence of a first language. For example, the input sentence may be generated by the data processing apparatus 10 based on audio and/or text data received by the data processing apparatus 10 from a user through an interface/sensor of the data processing apparatus 10 such as a microphone, keyboard, touch screen, and/or graphical user interface. The data processing apparatus 10 may generate a translation result of the input sentence (e.g. an output sentence) based on the generated output data. For example, a decoder of the data processing apparatus 10 may predict the output sentence based on the generated output data. The output sentence may be of a language different than a language of the input sentence.

The data processing apparatus 10 may include a processor 100 (e.g. one or more processors) and a memory 200.

The processor 100 may process data stored in the memory 200. The processor 100 may execute computer-readable instructions stored in the memory 200.

The processor 100 may be a data processing device implemented by hardware including a circuit having a physical structure to perform desired operations. For example, the desired operations may include instructions or codes included in a program.

For example, the hardware-implemented data processing device may include a microprocessor, a central processing unit (CPU), a processor core, a multi-core processor, a multiprocessor, an application-specific integrated circuit (ASIC), and/or a field programmable gate array (FPGA).

The processor 100 may generate the input vector by embedding the input data.

The processor 100 may convert the input data into a dense vector. When the input data is a natural language, the processor 100 may convert a corpus into a dense vector according to a predetermined standard.

For example, the processor 100 may convert the corpus into the dense vector based on a set of characters having a meaning. The processor 100 may convert the corpus into the dense vector based on phonemes, syllables, and/or words.

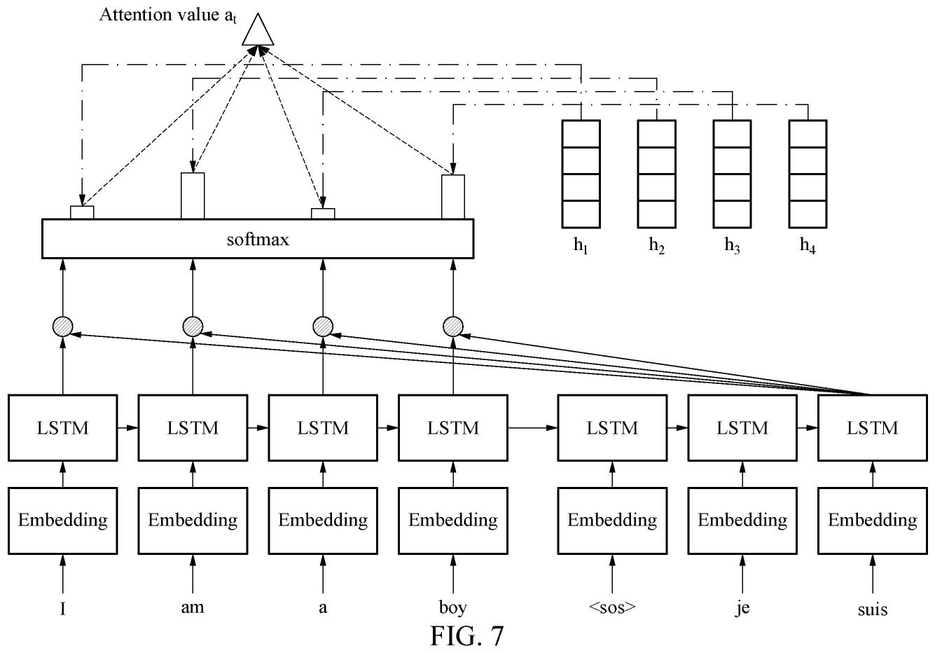

The processor 100 may generate the input vector by performing position embedding on the dense vector based on the position of the input data with respect to an entire input. Non-limiting example processes of the processor 100 performing position embedding will be described in further detail below with reference to FIGS. 6 and 7.

The processor 100 may convert a dimension of the input vector based on a pattern of the input vector. The pattern of the input vector may be a pattern of components of the input vector. The pattern of the input vector may indicate a predetermined form or style of values of the components of the input vector.

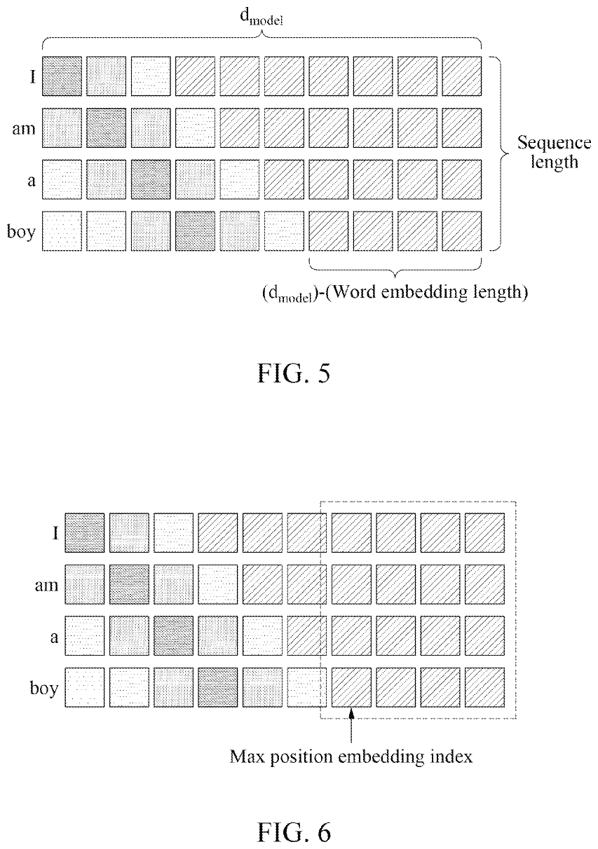

The processor 100 may determine an embedding index with respect to the input vector based on the pattern of the input vector. The processor 100 may determine an index corresponding to a boundary between a component used for attention and a component not used for attention, among the components of the input vector, to be the embedding index. For example, the component not used for attention may include “0”. Non-limiting example processes of the processor 100 determining the embedding index will be described in further detail below with reference to FIGS. 5 and 6.

The processor 100 may convert the dimension of the input vector based on the determined embedding index. For example, the processor 100 may reduce the dimension of the input vector by removing a component corresponding to an index greater than the embedding index from the input vector.

The processor 100 may perform attention on the dimension-converted input vector. Non-limiting example processes of the processor 100 performing attention will be described in further detail below with reference to FIG. 5.

The processor 100 may restore the dimension of the input vector on which the attention is performed. The processor 100 may restore the dimension of the input vector by reshaping the input vector on which the attention is performed. The reshaping may include an operation of reducing or expanding the dimension of the vector.

The processor 100 may increase the dimension of the input vector on which the attention is performed to the same dimension as the input vector based on the embedding index determined based on the pattern of the input vector.

For example, the processor 100 may restore the dimension of the input vector by performing zero padding on a component corresponding to an index greater than the embedding index with respect to the input vector on which the attention is performed.

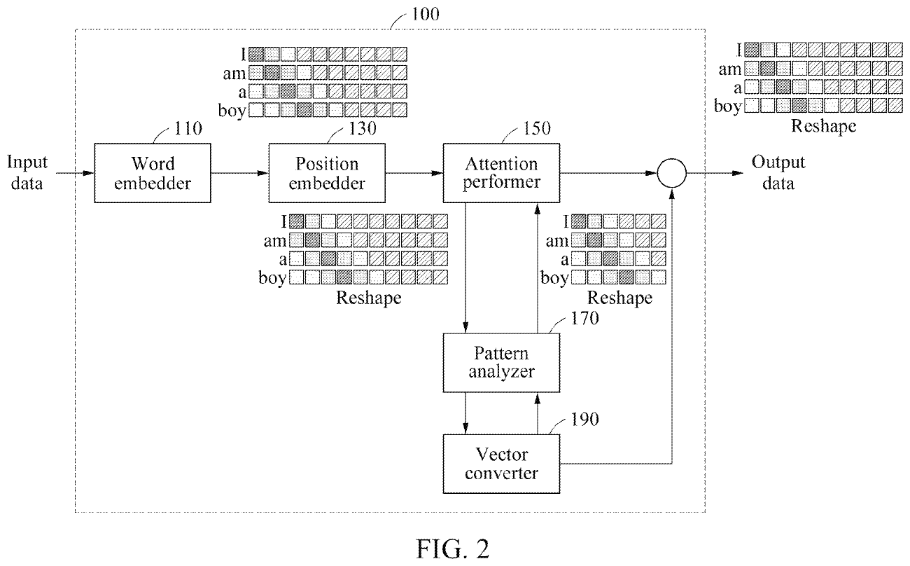

Non-limiting example processes of the processor 100 restoring the dimension of the input vector will be described in further detail below with reference to FIG. 2.

The memory 200 may store instructions (or a program) executable by the processor 100. For example, the instructions may include instructions to perform an operation of the processor 100 and/or an operation of each element of the processor 100.

The memory 200 may be implemented as a volatile memory device and/or a non-volatile memory device.

The volatile memory device may be implemented as a dynamic random access memory (DRAM), a static random access memory (SRAM), a thyristor RAM (T-RAM), a zero capacitor RAM (Z-RAM), and/or a Twin Transistor RAM (TTRAM).

The non-volatile memory device may be implemented as an electrically erasable programmable read-only memory (EEPROM), a flash memory, a magnetic RAM (MRAM), a spin-transfer torque(STT)-MRAM, a conductive bridging RAM(CBRAM), a ferroelectric RAM (FeRAM), a phase change RAM (PRAM), a resistive RAM(RRAM), a nanotube RRAM, a polymer RAM (PoRAM), a nano floating gate Memory(NFGM), a holographic memory, a molecular electronic memory device), and/or an insulator resistance change memory.

FIG. 2 illustrates an example of a processor (e.g., the processor 100 of FIG. 1).

Referring to FIG. 2, the processor 100 may include a word embedder 110, a position embedder 130, an attention performer 150, a pattern analyzer 170, and a vector converter 190.

The word embedder 110 may convert input data into a dense vector. The dense vector may also be referred to as an embedding vector, meaning a result of word embedding.

The dense vector may be a vector expressed by a dense representation having the opposite meaning of sparse representation. The sparse representation may be a representation method that represents most components of a vector as “0”. For example, the sparse representation may include a representation in which only one component of the vector is represented as “1”, like a one-hot vector generated using one-hot encoding.

The dense representation may be a representation method that represents input data using a vector having a size of a dimension arbitrarily set, without assuming the dimension of the vector as the size of the set of input data. The components of the dense vector may have real values other than “0” and “1”. Accordingly, the dimension of the vector may be dense, and thus a vector generated using the dense representation may be referred to as a dense vector.

As described above, the input data may include a text and/or an image. The word embedder 110 may convert the input data into the dense vector. The word embedder 110 may output the dense vector to the position embedder 130.

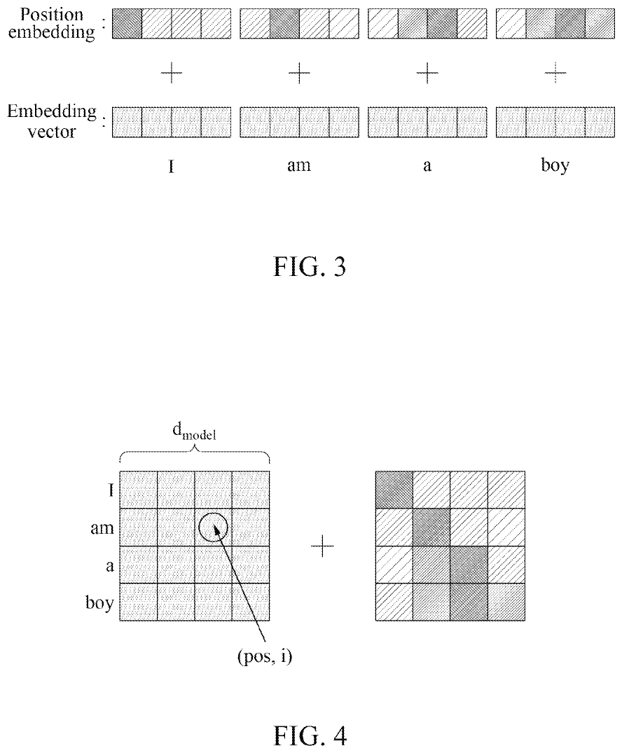

The position embedder 130 may generate an input vector by performing position embedding on the dense vector. The position embedder 130 may additionally assign position information to the dense vector. The position embedder 130 may output the generated input vector to the pattern analyzer 170 through the attention performer 150. Non-limiting example operations of the position embedder 130 will be described in further detail below with reference to FIGS. 3 and 4.

The pattern analyzer 170 may analyze a pattern of the input vector. The pattern analyzer 170 may determine an embedding index with respect to the input vector by analyzing the pattern of the input vector.

Non-limiting example operations of the pattern analyzer 170 determining the embedding index will be described in further detail below with reference to FIGS. 5 and 6.

The vector converter 190 may convert a dimension of the input vector based on the embedding index determined by the pattern analyzer 170. For example, the vector converter 190 may reduce the dimension of the input vector by removing a component corresponding to an index greater than the embedding index from the input vector. The vector converter 190 may output the dimension-converted input vector to the attention performer 150.

Non-limiting example operations of the vector converter 190 converting the dimension of the input vector will be described in further detail below with reference to FIGS. 5 and 6.

The attention performer 150 may perform attention on the input vector. The attention may include an operation of assigning an attention value to intensively view input data related to output data to be predicted by a decoder at a predetermined time. Non-limiting example operations of the attention performer 150 will be described in further detail below with reference to FIG. 7.

The attention performer 150 may output the input vector on which the attention is performed to the vector converter 190. The vector converter 190 may restore the dimension of the input vector on which the attention is performed. The attention performer 150 may restore the dimension of the input vector by reshaping the input vector on which the attention is performed.

The attention performer 150 may increase the dimension of the input vector on which the attention is performed to the same dimension as the input vector based on the embedding index determined based on the pattern of the input vector.

For example, the attention performer 150 may restore the dimension of the input vector by performing zero padding on a component corresponding to an index greater than the embedding index with respect to the input vector on which the attention is performed.

Through this, the data processing apparatus 10 may increase the memory efficiency at runtime and increase the system resource efficiency by removing inefficient operations that may occur when performing attention using the input vector (e.g., operations based on zero-value components of the input vector), thereby improving the functioning of data processing apparatuses, and improving the technology fields of encoder-decoder neural network data processing.

Non-limiting example operations of the word embedder 110 and the position embedder 130 will be further described below with reference to FIGS. 3 and 4.

FIG. 3 illustrates an example of a position embedding operation, and FIG. 4 illustrates an example of an embedding operation with respect to an entire input.

Referring to FIGS. 3 and 4, input data may have a relative or absolute position with respect to an entire input. The data processing apparatus 10 may perform position embedding on a dense vector, to generate an input vector by reflecting position information of each input data with respect to the entire input.

The word embedder 110 may convert the input data into a dense vector by performing word embedding on the input data. The example of FIG. 3 may be a case where the input data is a natural language.

In the examples of FIGS. 3 and 4, the input data may include “I”, “am”, “a”, and “boy”. The set of input data may constitute one sentence.

The input data may be sequentially input. The word embedder 110 may convert each input data into a dense vector. In the examples of FIGS. 3 and 4, the dimension of the vector may be expressed as “4”. However, examples are not limited thereto, and the dimension of the vector may be changed according to the type of input data. In this example, components of the dense vector may include real values.

The position embedder 130 may generate an input vector by performing position embedding on the dense vector. The position embedder 130 may perform position embedding on the dense vector based on the position of the input data with respect to the entire input.

In the examples of FIGS. 3 and 4, the entire input may be “I”, “am”, “a”, and “boy”. In this example, the position embedder 130 may perform position embedding on the dense vector according to the positions of the input data “I”, “am”, “a”, and “boy” in the entire input.

For example, the position embedder 130 may perform position embedding by adding corresponding position encoding values to the respective dense vectors.

The position encoding values may be expressed by Equations 1 and 2 below, for example.

PE_{(pos,2i)}=sin(pos/10000^{2i/d}^{_{model}}) Equation 1:

PE_{(pos,2i+1)}=cos(pos/10000^{2i/d}^{_{model}}) Equation 2:

In Equations 1 and 2, pos denotes the position of a dense vector with respect to the entire input, i denotes an index for a component in the dense vector, and d_{model} denotes the output dimension of a neural network used by the data processing apparatus 10 (or the dimension of the dense vector). The value of d_{model} may be changed, but a fixed value may be used when training the neural network.

The position embedder 130 may generate the position encoding value using a sine function value when an index of the dimension of the dense vector is even, and using a cosine function when the index of the dimension of the dense vector is odd.

That is, the input vector may be generated as a result of the word embedder 110 converting the input data into the dense vector and the position embedder 130 adding the dense vector and the position encoding value. An example process of generating the input vector with respect to the entire input is shown in FIG. 4.

For example, when the input is a natural language, and the dimension of the dense vector generated by the word embedder 110 is 512, and the length of the entire input is 50, the position embedder 130 may generate the input vector having a size of 50×512.

Hereinafter, non-limiting example operations of the pattern analyzer 170 and the vector converter 190 will be further described below with reference to FIGS. 5 and 6.

FIG. 5 illustrates an example of input data converted into an input vector, and FIG. 6 illustrates an example of an embedding index.

Referring to FIGS. 5 and 6, the pattern analyzer 170 may determine an embedding index by analyzing a pattern of an input vector, and convert a dimension of the input vector based on the embedding index.

If there is an input vector generated as shown in FIGS. 5 and 6, an unused portion of components of the input vector (e.g., a portion of the components for which values are not generated) may be used in a zero-padded form.

Due to such unnecessary components, unnecessary overhead may occur in subsequent neural network operations, such as attention. For example, as such components having zero values as a result of the zero-padding may not be used in the subsequent neural network operations, such as attention, storing or otherwise using such components may result in unnecessary memory or system resources overhead. Accordingly, the data processing apparatus 10 may improve the functioning of data processing apparatuses, and improving the technology fields of encoder-decoder neural network data processing, by converting the dimension of the input vector such that an inefficiency due to an unused area in the input vector is prevented.

The pattern analyzer 170 may determine the embedding index with respect to the input vector based on the pattern of the input vector. The pattern analyzer 170 may determine an index corresponding to a boundary between a component used for attention and a component not used for attention, among the components of the input vector, to be the embedding index. For example, the component not used for attention may include “0”.

In other words, the pattern analyzer 170 may determine an index of a starting point of zero padding to be the embedding index. The pattern analyzer 170 may store the determined embedding index in the memory 200.

That is, as described above, the zero-padded portion may not be used for the attention operation. Therefore, the pattern analyzer 170 may determine an index of a portion of the input vector at which zero padding starts, to be the embedding index.

Referring to the examples of FIGS. 5 and 6, the entire input vector may be formed of a sequence of input vectors, and the pattern analyzer 170 may determine an index of a starting point of zero padding (for example, the max position embedding index in FIG. 6) among the components of the input vector, to be the embedding index. For example, as the max position of the starting points of zero padding, among the sequence of input vectors of the entire input vector, is the starting point of zero padding of the input vector corresponding to “boy”, an index of such starting point may be the embedding index.

The vector converter 190 may convert the dimension of the input vector based on the determined embedding index. The vector converter 190 may reduce the dimension of the input vector by removing a component corresponding to an index greater than or equal to the embedding index from the input vector.

The vector converter 190 may output the dimension-converted input vector to the attention performer 150. The attention performer 150 may perform attention on the dimension-converted input vector. Hereinafter, the output of the attention performer 150 will be referred to as the input vector on which the attention is performed. The attention performer 150 may output the input vector on which the attention is performed to the vector converter 190 again.

The vector converter 190 may restore the dimension of the input vector on which the attention is performed. The vector converter 190 may restore the dimension of the input vector based on the embedding index. The vector converter 190 may restore the dimension of the input vector on which the attention is performed to the same dimension as that of the input vector before the dimension was converted, by performing zero padding on a component of a vector corresponding to an index greater than or equal to the embedding index. The vector converter 190 may finally output the restored vector.

That is, when the vector converter 190 removes unnecessary components from the input vector, performs attention, and restores the dimension of the input vector on which the attention is performed, a loss of the input data may be prevented.

The vector converter 190 may generate a single vector by concatenating input vectors on which the attention is performed to a final value corresponding to a predetermined time t. The vector converter 190 may concatenate a value corresponding to attention value(t), which is an attention value corresponding to the time t, with a hidden state of the decoder at a time t−1, and change an output value in that case.

The output restored by the vector converter 190 may be used as an input to the data processing device 10 again.

Unlike the example shown in FIG. 2, the pattern analyzer 170 and the vector converter 190 may be arranged in the attention performer 150, as necessary.

FIG. 7 illustrates an example of attention.

Referring to FIG. 7, the attention performer 150 may receive a dimension-converted input vector and perform attention thereon.

The attention may include an operation of an encoder referring to an entire input once again for each time-step in which a decoder predicts an output. The attention may include an operation of paying more attention (e.g., determining a greater weight value for use in a subsequent operation) to a portion corresponding to an input associated with an output that is to be predicted in the time-step, rather than referring to the entire input all at the same ratio.

The attention performer 150 may use an attention function as expressed by Equation 3 below, for example.

Attention(Q,K,V)=Attention Value Equation 3:

In Equation 3, Q denotes a query, K denotes keys, and V denotes values. For example, Q denotes a hidden state in a decoder cell at a time t−1, if a current time is t, and K and V denote hidden states of an encoder cell in all time-steps.

In this example, K denotes a vector for keys, and V denotes a vector for values. A probability of association with each word may be calculated through a key, and a value may be used to calculate an attention value using the calculated probability of association.

In this example, an operation may be performed with all the keys to detect a word associated with the query. Softmax may be applied after a dot-product operation is performed on the query and the key.

This operation may refer to expressing associations using probability values after the associations with all the keys are calculated with respect to a single query. Through this operation, a key with a high probability of association with the query may be determined. Then, scaling may be performed on a value obtained by multiplying the probability of association by the value.

The attention performer 150 may calculate an attention value through a weighted sum of an attention weight of the encoder and the hidden state. An output value of the attention function performed by the attention performer 150 may be expressed by Equation 4 below, for example.

$${a}_{t} = {\sum }_{i = 1}^{N} {α}_{i}^{t} {h}_{i} \qquad Equation 4$$

In Equation 4, aₜ denotes an attention value at a time t, and h denotes a weight. That is, Equation 4 may be an operation of obtaining a weighted sum of an i-th vector of the encoder and an attention probability value.

The weighted sum may be an operation of multiplying word vectors by attention probability values and then adding all the result values. In detail, the weighted sum may refer to multiplying hidden states of encoders by attention weights and adding all the result values to obtain a final result of the attention.

The attention performer 150 may perform the attention in various manners. The types of attentions that may be performed by the attention performer 150 include nay one or any combination of the types of attentions shown in Table 1 below, for example.

TABLE 1

| Name | Attention score function |
|---|---|
| Content-base attention | score(sᵢ, hᵢ) = cosine[sᵢ, hᵢ] |
| Additive | score(sᵢ, hᵢ) = vₐ^{τ} tanh(Wₐ[sᵢ; hᵢ]) |
| Location-base | α_{t,i} = softmax(Wₐsᵢ) |
| General | score(sᵢ, hᵢ) = sᵢ^{τ}Wₐhᵢ where Wₐ is a trainable weight matrix in the attention layer. |
| Dot-Product | score(sᵢ, hᵢ) = sᵢ^{τ}hᵢ |
| | $score ( {s}_{i} , {h}_{i} ) = \frac{{s}_{i}^{τ} {h}_{i}}{\sqrt{n}}$ |

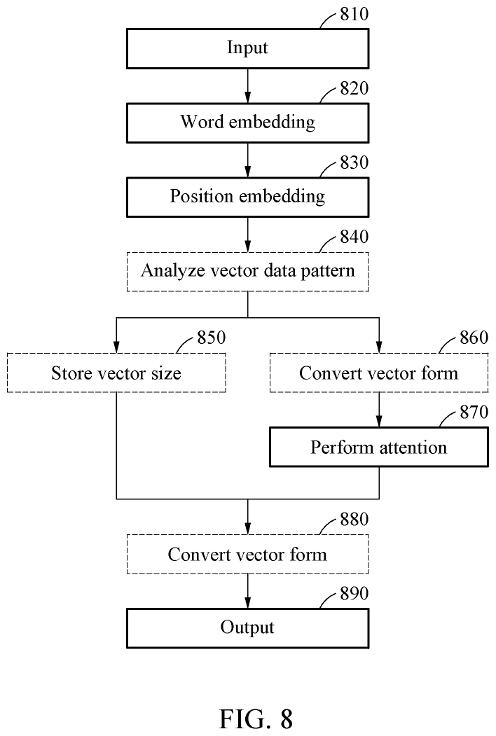

FIG. 8 illustrates an example of an operation of a processor (e.g., the processor 100 of FIG. 1).

Referring to FIG. 8, in operation 810, the word embedder 110 may receive input data and perform word embedding thereon. The word embedder 110 may perform the word embedding by converting a word to the form of a dense vector. As described above, the dense vector may be referred to as an embedding vector. The word embedder 110 may output the dense vector to the position embedder 130.

In operation 820, the position embedder 130 may perform position embedding. The position embedder 130 may generate an input vector by performing position embedding on the dense vector. The position embedder 130 may output the generated input vector to the pattern analyzer 170.

The process of the position embedder 130 performing the position embedding may be as described above with reference to FIGS. 1-7. Through the position embedding, information related to a relative or absolute position of the input data to an entire input may be injected into the input vector.

For example, if the input data is a natural language, the entire input may be a single sentence, and the position embedding may be performed to inject position information of words included in the single sentence. That is, the position embedding may be performed to determine the context and a positional relationship between words in the single sentence.

In operation 840, the pattern analyzer 170 may analyze a pattern of the input vector. The pattern analyzer 170 may determine the embedding index based on the pattern of the input vector. In operation 850, the pattern analyzer 170 may output the determined embedding index to the vector converter 190, and store the determined embedding index in the memory 200. In this example, the pattern analyzer 170 may store the embedding index, thereby using the embedding index to restore the input vector on which the attention is performed.

The pattern analyzer 170 may analyze vector information related to the embedded input vector. If the entire input is a sentence, the input vector may include an embedding value including a word and position information of the word, and some components may include “1” and “0” or real values.

The pattern analyzer 170 may determine that an unused value, for example, a value such as 0, is used to represent a dimension of the input vector, and search for an index corresponding to a boundary of a region of a meaningful value. The pattern analyzer 170 may determine the index corresponding to the boundary to be the embedding index.

The process of the pattern analyzer 170 determining the embedding index may be as described above with reference to FIGS. 5 and 6.

In operation 860, the vector converter 190 may convert the form (for example, the dimension) of the input vector based on the embedding index. The vector converter 190 may reduce the dimension of the vector by removing a component of the input vector corresponding to an index greater than or equal to the embedding index. The vector converter 190 may output the dimension-converted input vector to the attention performer 150.

The vector converter 190 may convert the input vector into a vector having a new dimension through vector conversion, thereby preventing spatial waste and inefficient operation of a matrix used to perform attention in operation 870.

In operation 870, the attention performer 150 may perform attention on the dimension-converted input vector. The process of the attention performer 150 performing the attention may be as described above with reference to FIG. 7. The attention performer 150 may output the input vector on which the attention is performed to the vector converter 190.

The attention performer 150 may refer to the entire input in an encoder once again, for each time-step in which a decoder predicts an output, when performing the attention. In this example, the attention performer 150 may pay more attention to an input portion associated with an output that is to be predicted in the time-step, rather than referring to the entire input at the same ratio.

The attention performer 150 may calculate an attention score and calculate an attention distribution through the softmax function.

The attention performer 150 may calculate an attention value by obtaining a weighted sum of an attention weight and a hidden state of each encoder, and concatenate the attention value with a hidden state of a decoder at a time t−1.

When the entire input is a sentence of a natural language, the data processing device 10 may perform a machine translation field, an association between sentences, and inference of a word in one sentence through attention.

In operation 880, the vector converter 190 may convert (for example, restore) the form (for example, the dimension) of the input vector on which the attention is performed. The vector converter 190 may convert the input vector on which the attention is performed to have the same form as the input vector before the attention was performed in operation 870 and before the form was converted in operation 860. The process of the vector converter 190 restoring the dimension of the input vector on which the attention is performed may be as described in FIGS. 5 and 6.

Finally, the vector converter 190 may output a vector of a time t, in which the weight at the time t−1 is reflected.

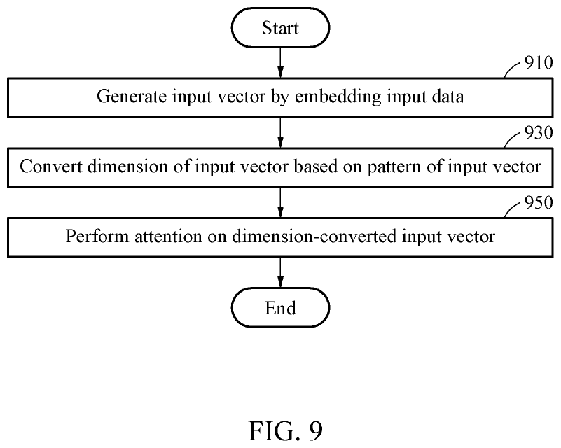

FIG. 9 illustrates an example of an operation of a data processing apparatus (e.g., the data processing apparatus 10 of FIG. 1).

Referring to FIG. 9, in operation 910, the processor 100 may generate an input vector by embedding input data. The processor 100 may convert the input data into a dense vector. The processor 100 may generate the input vector by performing position embedding on the dense vector based on the position of the input data with respect to an entire input.

In operation 930, the processor 100 may convert a dimension of the input vector based on a pattern of the input vector. The processor 100 may determine an embedding index with respect to the input vector based on the pattern of the input vector. The processor 100 may determine an index corresponding to a boundary between a component used for attention and a component not used for attention, among the components of the input vector, to be the embedding index. For example, the component not used for attention may include “0”.

The processor 100 may convert the dimension of the input vector based on the determined embedding index. For example, the processor 100 may reduce the dimension of the input vector by removing a component corresponding to an index greater than the embedding index from the input vector.

In operation 950, the processor 100 may perform attention on the dimension-converted input vector.

The processor 100 may restore the dimension of the input vector on which the attention is performed. The processor 100 may restore the dimension of the input vector by reshaping the input vector on which the attention is performed. Reshaping may include an operation of reducing or expanding the dimension of the vector.

The processor 100 may increase the dimension of the input vector on which the attention is performed to the same dimension as the input vector based on the embedding index determined based on the pattern of the input vector.

For example, the processor 100 may restore the dimension of the input vector by performing zero padding on a component corresponding to an index greater than the embedding index with respect to the input vector on which the attention is performed.

The data processing apparatuses, processors, memories, data processing apparatus 10, processor 100, memory 200, apparatuses, units, modules, devices, and other components described herein with respect to FIGS. 1-12 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions used herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A data processing method, comprising:
generating an input vector by embedding input data;
converting a dimension of the input vector based on a pattern of the input vector; and
performing attention on the dimension-converted input vector.

2. The method of claim 1, wherein the generating comprises:
converting the input data into a dense vector; and
generating the input vector by performing position embedding on the dense vector based on the position of the input data with respect to an entire input.

3. The method of claim 1, wherein the converting comprises:
determining an embedding index with respect to the input vector based on the pattern of the input vector; and
converting the dimension of the input vector based on the embedding index.

4. The method of claim 3, wherein the determining comprises determining, as the embedding index, an index corresponding to a boundary between a component to be used in the performing of the attention and a component not to be used in the performing of the attention, among components of the input vector.

5. The method of claim 3, wherein the component not to be used in the performing of the attention includes a value of “0”.

6. The method of claim 3, wherein the converting of the dimension of the input vector based on the embedding index comprises reducing the dimension of the input vector by removing a component corresponding to an index greater than the embedding index from the input vector.

7. The method of claim 4, wherein
the input vector comprises a plurality of input vectors, and
the embedding index is an index having a max position among indices corresponding to boundaries between components of the input vectors to be used in the performing of the attention and components of the input vectors not to be used in the performing of the attention.

8. The method of claim 1, further comprising:
restoring the dimension of the input vector on which the attention is performed.

9. The method of claim 8, wherein the restoring comprises increasing the dimension of the input vector on which the attention is performed to the same dimension as the input vector based on an embedding index determined based on the pattern of the input vector.

10. The method of claim 9, wherein the increasing comprises performing zero padding on a component corresponding to an index greater than or equal to the embedding index with respect to the input vector on which the attention is performed.

11. The method of claim 1, further comprising:
generating an output sentence as a translation of an input sentence, based on the input vector on which the attention is performed,
wherein the input data corresponds to the input sentence.

12. A non-transitory computer-readable storage medium storing instructions that, when executed by a processor, configure the processor to perform the method of claim 1.

13. A data processing apparatus, comprising:
a processor configured to:
generate an input vector by embedding input data,
convert a dimension of the input vector based on a pattern of the input vector, and
perform attention on the dimension-converted input vector.

14. The apparatus of claim 13, wherein, for the generating, the processor is configured to:
convert the input data into a dense vector, and
generate the input vector by performing position embedding on the dense vector based on the position of the input data with respect to an entire input.

15. The apparatus of claim 13, wherein, for the converting, the processor is configured to:
determine an embedding index with respect to the input vector based on the pattern of the input vector, and
convert the dimension of the input vector based on the embedding index.

16. The apparatus of claim 15, wherein, for the determining, the processor is configured to determine, as the embedding index, an index corresponding to a boundary between a component to be used in the performing of the attention and a component not to be used in the performing of the attention, among components of the input vector.

17. The apparatus of claim 15, wherein the component not to be used in the performing of the attention includes a value of “0”.

18. The apparatus of claim 15, wherein, for the converting, the processor is configured to reduce the dimension of the input vector by removing a component corresponding to an index greater than or equal to the embedding index from the input vector.

19. The apparatus of claim 13, wherein the processor is configured to restore the dimension of the input vector on which the attention is performed.

20. The apparatus of claim 19, wherein, for the restoring, the processor is configured to increase the dimension of the input vector on which the attention is performed to the same dimension as the input vector based on an embedding index determined based on the pattern of the input vector.

21. The apparatus of claim 20, wherein, for the increasing, the processor is configured to perform zero padding on a component corresponding to an index greater than the embedding index with respect to the input vector on which the attention is performed.

22. The apparatus of claim 13 further comprising a memory storing instructions that, when executed by the processor, configure the processor to perform the generating of the input vector, the converting of the dimension of the input vector, and the performing of the attention on the dimension-converted input vector.
